(19) United States
(12) Patent Application Publication
(10) Pub. No.: US 2009/0291669 A1
(43) Pub. Date: Nov. 26, 2009

(54) METHOD FOR CREATING PHOTO FILES IN ACCORDANCE WITH SCHEDULER FUNCTION AND MOBILE COMMUNICATION TERMINAL SUPPORTING THE SAME

(75) Inventors: Woo-Jun CHOI, Suwon-si (KR); Young-Seop HAN, Daegu (KR); Dae-Hyun SIM, Seoul (KR); Beom-Soo CHO, Suwon-si (KR); Nam-Hoon KIM, Suwon-si (KR); Sung KWON, Anyang-si (KR)

Correspondence Address: THE FARRELL LAW FIRM, LLP, 290 Broadhollow Road, Suite 210E, Melville, NY, 11747, US

(73) Assignee: SAMSUNG ELECTRONICS CO., LTD., Suwon-si (KR)

(21) Appl. No.: 12/472,108

(22) Filed: May 26, 2009

(30) Foreign Application Priority Data
May 23, 2008 (KR) 10-2008-0048240

(51) Int. Cl. H04L 12/58; H04B 7/00

(52) U.S. Cl. 455/412.1; 455/41.3

(57) ABSTRACT

A method for creating a photo file while photographing with a camera mounted in a mobile communication terminal. The mobile communication terminal determines whether schedule information associated with a photographing time exists in a scheduler program, and creates photo file information including the schedule information when schedule information associated with the photographing time exists.

### PRIORITY

This application claims priority under 35 U.S.C. § 119(a) to a Korean Patent Application filed in the Korean Intellectual Property Office on May 23, 2008 and assigned Serial No. 10-2008-0048240, the entire disclosure of which is incorporated herein by reference.

### BACKGROUND OF THE INVENTION

1. Field of the Invention

The present invention relates generally to a method for creating photo folders and photo files during photographing in a mobile communication terminal. More particularly, the present invention relates to a method for creating photo folders and photo files in accordance with a scheduler function during photographing in a mobile communication terminal, and a mobile communication terminal supporting the same.

2. Description of the Related Art

In general, mobile communication service providers offer users functions linked with their communication functions, including wireless Internet access, Video-on-Demand (VoD) service, text/multimedia message delivery, and wireless online gaming. However, mobile communication terminal manufacturers provide users with terminal-dependent functions that are not linked with communication functions, including camera, notepad, phonebook, scheduler, and morning call functions.

Among the functions provided in mobile communication terminals, the scheduler function can manage a schedule of a terminal user by storing event details (or schedule content), event dates, event locations, event times, persons, repetition/non-repetition of events, or the like, and inform the user of the stored schedule information using bells and/or vibrations at scheduled times.

Most mobile communication terminals are currently equipped with a built-in camera, allowing users to freely take pictures and store them anytime and anyplace. Generally, when an object is photographed using a camera in a mobile communication terminal, a file name of the currently photographed picture is automatically created and displayed based on the present date and time. The user then stores the automatically created file name as it is, or changes the file name at his/her discretion, and stores it in a storage space in the mobile communication terminal.

However, it may be difficult for the user to check details of photos stored in the mobile communication terminal, and it may be inconvenient to put the photos in order, if the names of the image files are viewed without the stored images. The user may rename the image files one by one while storing the image files, but this may also be inconvenient for the user. In addition, as the terminals become more intelligent, there is an increasing tendency to attach additional tags to the photos and use them as context information.

### SUMMARY OF THE INVENTION

The present invention has been made to address at least the above problems and/or disadvantages and to provide at least the advantages described below. Accordingly, an aspect of the present invention provides a method for setting and storing names of photo folders and photo files in accordance with a user's schedule information associated with a photographing time while photographing with a camera mounted in a mobile communication terminal, and a mobile communication terminal supporting the same.

According to one aspect of the present invention, a method is provided for creating a photo file while photographing with a camera mounted in a mobile communication terminal. It is determined whether schedule information associated with a photographing time exists in a scheduler program in the mobile communication terminal. Photo file information is created including the schedule information when schedule information associated with the photographing time exists.

According to another aspect of the present invention, a mobile communication terminal is provided for creating a photo file. The mobile communication terminal includes a camera module for converting an image photographed by a camera lens into a digital signal, and creating image information by capturing consecutive digital signals in a still image. The mobile communication terminal also includes a memory for storing a plurality of programs and information necessary for controlling an operation of the mobile communication terminal, and storing a scheduler program for a user. The mobile communication terminal further includes a controller for controlling the operation of the mobile communication terminal, determining whether previously registered schedule information associated with a photographing time exists in the scheduler program while storing a photo file after photographing, and creating photo file information including the previously registered schedule information when the previously registered schedule information associated with the photographing time exists.

### BRIEF DESCRIPTION OF THE DRAWINGS

The above and other aspects, features and advantages of the present invention will be more apparent from the following description when taken in conjunction with the accompanying drawings, in which:

FIG. 1 is a block diagram of an apparatus for creating photo folders and photo files in accordance with a scheduler function, according to an embodiment of the present invention;

FIG. 2 is a flowchart illustrating an operation of a mobile communication terminal in a photo folder and photo file creation method in accordance with a scheduler function, according to an embodiment of the present invention;

FIG. 3 is a flowchart illustrating an operation of an adjacent mobile communication terminal that has received a schedule request in a photo folder and photo file creation method, according to an embodiment of the present invention;

FIG. 4 illustrates an example of a photo folder and photo file creation operation when there is a registered schedule associated with a photographing time in a photo folder, and a photo file creation method operating in accordance with a scheduler function, according to an embodiment of the present invention; and

FIG. 5 illustrates an example of a photo folder and photo file creation operation when there is no registered schedule associated with a photographing time in a photo folder, and a photo file creation method operating in accordance with a scheduler function, according to an embodiment of the present invention.

### DETAILED DESCRIPTION OF PREFERRED EMBODIMENTS

Preferred embodiments of the present invention are described in detail with reference to the accompanying drawings. The same or similar components may be designated by the same or similar reference numerals although they are illustrated in different drawings. Detailed descriptions of constructions or processes known in the art may be omitted to avoid obscuring the subject matter of the present invention.

The terms and words used in the following description and claims are not limited to their dictionary meanings, but, are merely used by the inventor to enable a clear and consistent understanding of the invention. Accordingly, it should be apparent to those skilled in the art that the following description of preferred embodiments of the present invention are provided for illustrative purposes only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The present invention provides a method for setting names of photo folders, photo files, and additional tags based on previously stored schedule information of a scheduler function embedded in a mobile communication terminal, while taking pictures using a camera mounted in the mobile communication terminal. In addition, when there is no stored schedule information during photographing, the user may receive schedule information from his/her surrounding friends or colleagues over a Personal Area Network (PAN) (for example, Bluetooth, ZigBee, or the like), add them to his/her schedule, and make reference to the resulting schedule in creating photo files.

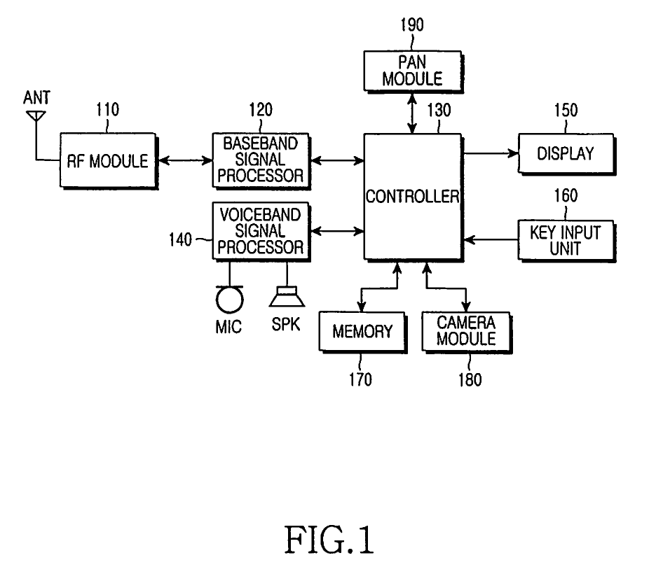

FIG. 1 is a block diagram of an apparatus for creating photo folders and photo files in accordance with a scheduler function, according to an embodiment of the present invention.

A mobile communication terminal according to the present invention includes a Radio Frequency (RF) module 110, a baseband signal processor 120, a controller 130, a voiceband signal processor 140, a display 150, a key input unit 160, a memory 170, a camera module 180, and a PAN module 190.

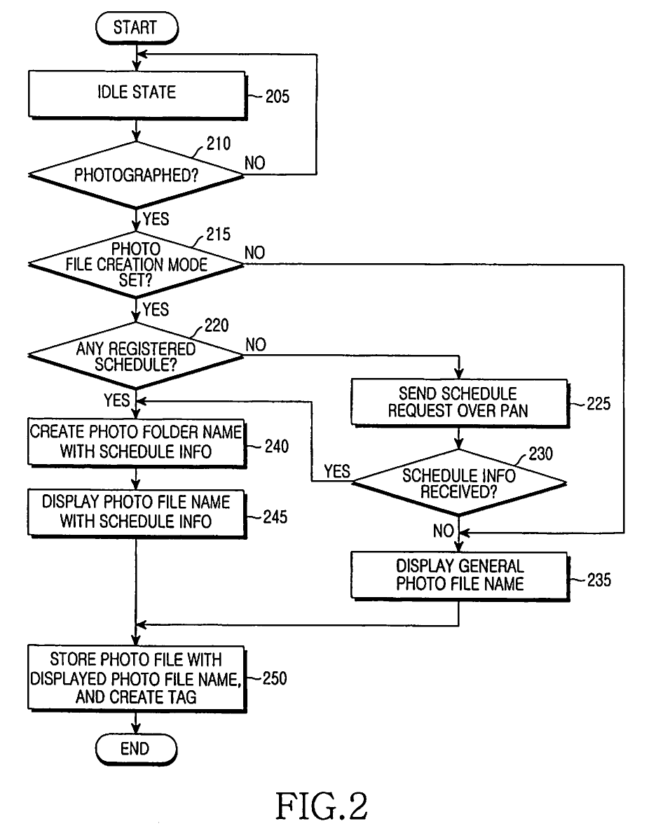

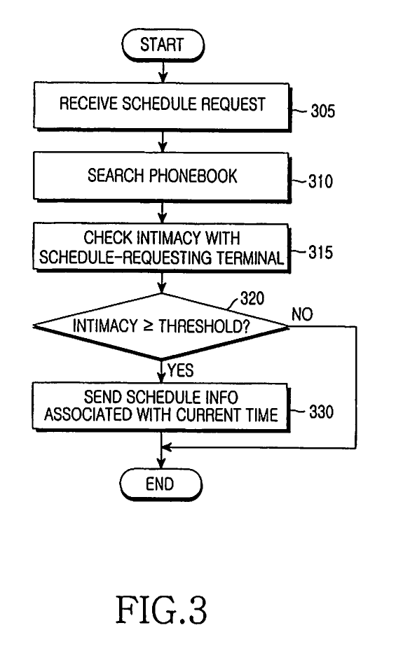

The controller 130 controls the overall operation of the mobile communication terminal, including a call and data transmission/reception operation. Particularly, in an embodiment of the present invention, the controller 130 controls respective elements such that during photographing with the mobile communication terminal, a scheduler program in the mobile communication terminal determines whether schedule information associated with the photographing time have been registered. The controller 130 sets names of photo files with information from the schedule if there is previously registered schedule information with which the photographing time is associated. An operation of the controller 130 will be described in detail with reference to FIGS. 2 and 3.

The key input unit 160 includes a plurality of alphanumeric keys and function keys, and outputs key data associated with the keys to the controller 130.

The display 150 receives display data corresponding to the key data output from the key input unit 160, from the controller 130, and displays the received display data. The display 150 displays a variety of messages under the control of the controller 130. Also, the display 150 receives image data like video data and still image data from the controller 130, and displays the received image data. The display 150 may include any one of Liquid Crystal Display (LCD), Thin Film Transistor (TFT), Organic Electroluminescence (EL), and the like.

The camera module 180 converts images photographed by a camera lens into digital signals, and creates image data by capturing the consecutive digital signals in still images, or creates video data by capturing the consecutive videos for a predetermined time.

The memory 170 includes a Read Only Memory (ROM) and a Random Access Memory (RAM) to store a plurality of programs and information necessary to control an operation of the mobile communication terminal. Particularly, in an embodiment of the present invention, the memory 170 stores programs for enabling the controller 130 to perform the above-described operation proposed by the present invention. Further, the memory 170 stores a user's scheduler program. The scheduler program, a program for managing a user's schedule, stores at least one of dates, times and details of scheduled events, and may further store persons, repetition/non-repetition of scheduled events, generation/non-generation of alarms at scheduled times, ways to generate alarms, etc.

Commonly, the mobile communication terminal performs wireless communication with a base station. For the wireless communication, the RF module 110 exchanges RF signals with the base station via an antenna ANT. During signal reception, the RF module 110 converts a received RF signal into an Intermediate Frequency (IF) signal and outputs the IF signal to the baseband signal processor 120. During signal transmission, the RF module 110 converts an IF signal input from the baseband signal processor 120 into an RF signal and transmits the RF signal over the air.

The baseband signal processor 120 converts a baseband digital signal applied from the controller 130 into an analog IF signal and applies it to the RF module 110. The baseband signal processor 120 converts an analog IF signal applied from the RF module 110 into a baseband digital signal and applies it to the controller 130.

The voiceband signal processor 140, connected to the controller 130, is coupled to a microphone MIC and a speaker SPK. When a call is connected, the voiceband signal processor 140 converts voice signals received from the microphone into voice data and outputs it to the controller 130. Further, the voiceband signal processor 140 converts voice data input from the controller 130 into audible sounds through the speaker.

The PAN module 190 enables communication with other adjacent mobile communication terminals using a PAN. Herein, a Bluetooth communication module or a ZigBee communication module can be used as the PAN module 190. The Bluetooth communication module wirelessly forms a Bluetooth connection to another terminal having a Bluetooth communication module, and the ZigBee communication module enables ZigBee communication with another terminal having a ZigBee communication module. The mobile communication terminal, according to an embodiment of the present invention, forms a PAN, or a local area network, using the PAN module 190, and enables transmission/reception of the schedule information provided by the present invention.

FIG. 2 is a flowchart illustrating an operation of a mobile communication terminal in a photo folder and photo file creation method in accordance with a scheduler function, according to an embodiment of the present invention.

Referring to FIG. 2, a mobile communication terminal keeps an idle state in step 205, and determines, in step 210, whether a photograph has been taken by the camera module 180 in the mobile communication terminal. If a photograph has been taken, the mobile communication terminal proceeds to step 215, and otherwise, returns to step 205 where it continues in the idle state.

In step 215, the mobile communication terminal determines if a photo file creation mode interlocked with the scheduler function is set therein. If it is determined that the photo file creation mode interlocked with the scheduler function is not set in the terminal, the mobile communication terminal sets and displays a general photo file name, consisting of the photographed date and time and its sequence number, on the photographed image, in step 235. Thereafter, in step 250, the mobile communication terminal stores the photo file with the photo file name displayed in step 235, and creates a tag. If the displayed photo file name is changed by the user, the mobile communication terminal stores the photo file with the changed photo file name and creates a tag, completing the operation.

Returning to step 215, if it is determined that the photo file creation mode interlocked with the scheduler function is set in the terminal, the mobile communication terminal checks a schedule stored in a scheduler program in step 220 to determine if there is any registered schedule information associated with the time of the photograph. If there is no registered schedule information associated with the current time, the mobile communication terminal sends a schedule request to adjacent terminals using a PAN in step 225. Thereafter, in step 230, the mobile communication terminal determines if it has received schedule information from the adjacent terminals in response to the schedule request. If it is determined in step 230 that no schedule information has been received in reply to the schedule request, the mobile communication terminal sets and displays a general photo file name having the date and time of the photograph and its sequence number in step 235. Thereafter, in step 250, the mobile communication terminal stores the photo file with the photo file name displayed in step 235, and creates a tag. If the displayed photo file name is changed by the user, the mobile communication terminal stores the photo file with the changed photo file name, and creates a tag, completing the operation.

If schedule information has been received in response to the schedule request in step 230, the mobile communication terminal proceeds to step 240. Also, if it is determined in step 220 that there is registered schedule information associated with the time of the photograph, the mobile communication terminal similarly proceeds to step 240.

In step 240, the mobile communication terminal creates a photo folder in which photo files are to be stored, using information from the schedule about the event associated with the photographing time. According to an embodiment of the present invention, the mobile communication terminal creates a name of a photo folder, in which photo files are to be stored, with information on event details, event location and event date in the stored schedule information. If the event details are too long, only a predetermined leading part of the details can be used in creating the name of the photo folder. In step 245, the mobile communication terminal sets and displays photo file names including the schedule information. The photo file names are created in the same manner as the name of the photo folder in which the photo files are to be stored, and sequence numbers are added to the photo file names. In step 250, the mobile communication terminal stores the photo file with the photo file name displayed in step 245, and creates a tag. If the displayed photo file name was changed by the user, the mobile communication terminal stores the photo file with the changed photo file name, and creates a tag. Even in this case, information on event details, event location, event date and event time can be added to the photo file as a tag. Subsequently, the terminal ends the operation.

FIG. 3 is a flowchart illustrating an operation of an adjacent mobile communication terminal that has received a schedule request in a photo folder and photo file creation method, according to an embodiment of the present invention.

Referring to FIG. 3, when a mobile communication terminal that has taken a picture sends a schedule request signal to adjacent mobile communication terminals, each adjacent mobile communication terminal receives the schedule request signal in step 305. In step 310, the terminal that received the schedule request searches a phonebook stored therein for the terminal that sent the schedule request signal, and proceeds to step 315 where it checks its intimacy with the schedule-requesting terminal. The intimacy check in step 315 may be performed in various manners. In an embodiment of the present invention, the terminal may determine that it is intimate with a specific terminal, when its phonebook has a phone number of the specific terminal. To check the intimacy more accurately, the terminal may check the intimacy by analyzing its call frequency, call time, message exchange frequency, etc. with the specific terminal. Further, the terminal may check the intimacy by determining whether a separate bell is appointed to a phone number of the specific terminal, and whether a photo is registered in association with the specific phone number.

If it is determined in step 320 that the checked intimacy is greater than or equal to a predetermined threshold, the terminal transmits, in step 330, schedule information associated with the current time to the mobile communication terminal that sent the schedule request signal, completing the operation. When the checked intimacy is less than the threshold in step 320, the terminal immediately ends the operation.

The terminal may also terminate the operation when its phonebook does not have a phone number of the terminal that sent the schedule request signal as a result of the phonebook search in step 310.

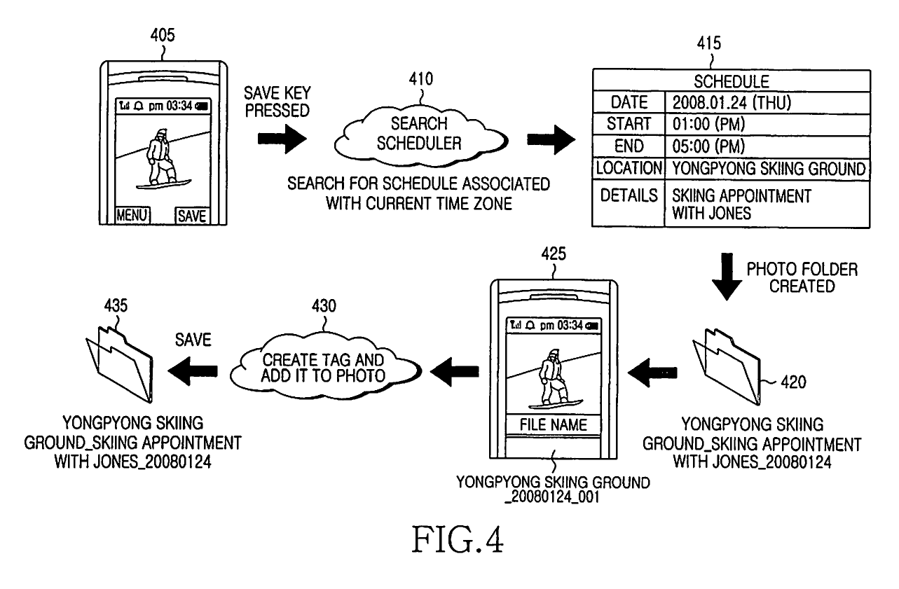

FIG. 4 illustrates an example of a photo folder and photo file creation operation when there is registered schedule information associated with a photographing time in a photo folder, and a photo file creation method in accordance with a scheduler function, according to an embodiment of the present invention.

Referring to FIG. 4, a user takes a photograph using a camera mounted in a mobile communication terminal. In step 405, the photograph with a person skiing at 3:34 pm is displayed on a display of the terminal. If the user inputs a Save key, the mobile communication terminal searches a scheduler (or a scheduler program) in step 410. An event “Skiing Appointment with Jones from 1:00 pm to 5:00 pm on Thursday in 24 Jan. 2008” is registered in the scheduler as indicated by reference numeral 415. Since the photographed current time of 3:34 pm belongs to the event time of 1:00 pm to 5:00 pm, the terminal can determine in step 415 that the event is associated with the current photograph. Accordingly, the mobile communication terminal creates a photo folder according to characteristics of the present invention. The photo folder is created with the searched schedule information. In an embodiment of the present invention, a name of the photo folder is set with the event location, event details, and event date. In the example of FIG. 4, the folder name is set as “Yongpyong Skiing Ground_Skiing Appointment with Jones_{—}20080124” in step 420. Subsequently, the mobile communication terminal sets a photo file name consisting of the event location, the event details, the event date and a file sequence number, and displays it on the display. Therefore, in this example, the file name is set as “Yongpyong Skiing Ground_Skiing Appointment with Jones_{—}20080124_{—}001” and displayed on the display in step 425. If the user agrees to the file name after checking the display, the terminal stores the photo with the file name, creates a tag and attaches it to the photo in step 430. The terminal stores the photo in the photo folder in step 435.

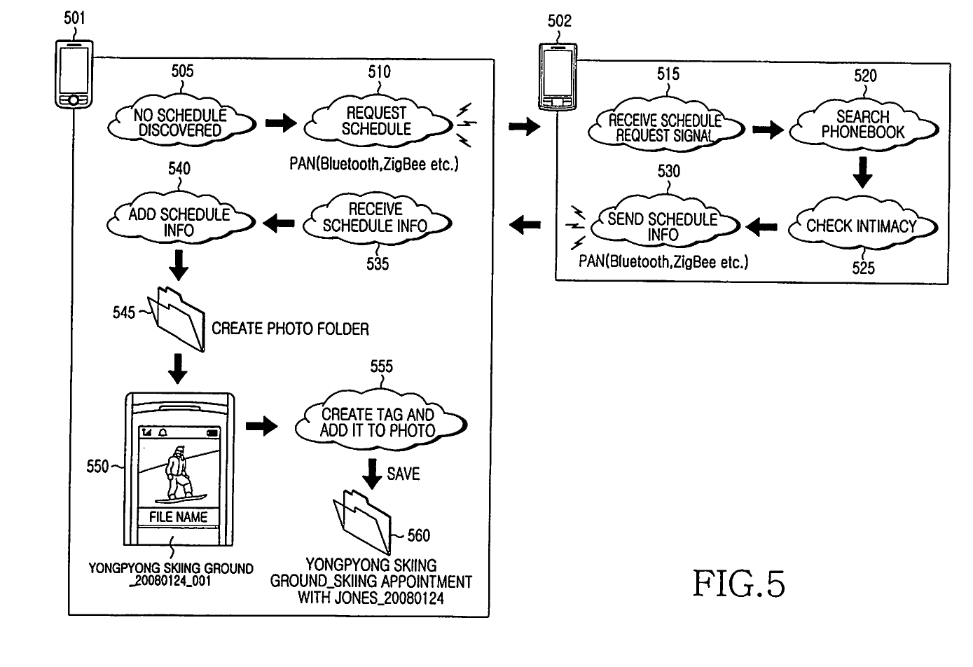

FIG. 5 illustrates an example of a photo folder and photo file creation operation when there is no registered schedule information associated with a photographing time in a photo folder, and a photo file creation method in accordance with a scheduler function, according to an embodiment of the present invention.

When no schedule information associated with a picture photographed by a mobile communication terminal 501 is found in step 505, the terminal 501 searches for terminals of friends or colleagues among surrounding people using a PAN. If they are in the neighboring area in that time zone and have their registered schedules, there is a high possibility that they will have the same schedule as the user of the terminal. Therefore, the mobile communication terminal 501 sends a schedule request signal to neighboring terminals using the PAN (Bluetooth or ZigBee in an embodiment of the present invention) in step 510.

Then, an adjacent mobile communication terminal 502 receives the schedule request signal in step 515, and searches its own phonebook to find out the terminal that sent the schedule request signal in step 520. Thereafter, the terminal 502 checks its intimacy with the mobile communication terminal 501 that sent the schedule request signal, in a predetermined manner in step 525. If the intimacy is greater than or equal to a threshold, and determines that they are friends or colleagues, the terminal 502 sends its schedule information to the mobile communication terminal 501 using the PAN in step 530.

The mobile communication terminal 501 then receives the schedule information from the adjacent mobile communication terminal 502 in step 535, and adds the received schedule information to a scheduler program in step 540. Subsequently, the terminal sets a name of a photo folder with the received schedule information in step 545. The photo folder is created such that its name includes the searched schedule information. In an embodiment of the present invention, the folder name is set using the event location, the event details, and the event date. Next, the mobile communication terminal sets a photo file name including the event location, the event details, the event date, and its file sequence number, and displays it on the display in step 550. When the user agrees to the file name after checking the display, the terminal stores the photo with the file name, creates a tag, and adds it to the photo in step 555. The terminal stores the photo in the photo folder in step 560.

As is apparent from the foregoing description, the present invention can create names of photo folders and photo files based on registered events associated with a photographing time in accordance with a scheduler function of a conventional terminal, while a user takes pictures using a camera mounted in the mobile communication terminal. The user can set and store names of photo files in more detail compared with the conventional method, even though it stores images with the default file names without additional manipulation. In addition, the user can grasp the details of photo files stored in the mobile communication terminal by simply reading default names of the photo files without viewing the stored images in person. Further, since the user can receive schedule information from neighboring friends or colleagues using the PAN, and make reference to it in creating photo files, the user can perform photo file creation in accordance with the scheduler function even when he/she has failed to register the events in advance.

Embodiments of the present invention can also be embodied as computer-readable codes on a computer-readable recording medium. The computer-readable recording medium is any data storage device that can store data, which can thereafter be read by a computer system. Examples of the computer-readable recording medium include, but are not limited to, Read-Only Memory (ROM), Random-Access Memory (RAM), CD-ROMs, magnetic tapes, floppy disks, optical data storage devices, and carrier waves (such as data transmission through the Internet via wired or wireless transmission paths). The computer-readable recording medium can also be distributed over network-coupled computer systems so that the computer-readable code is stored and executed in a distributed fashion. Also, function programs, codes, and code segments for accomplishing the present invention can be easily construed as within the scope of the invention by programmers skilled in the art to which the present invention pertains.

While the invention has been shown and described with reference to certain preferred embodiments thereof, it will be understood by those skilled in the art that various changes in form and detail may be made therein without departing from the spirit and scope of the invention as defined by the appended claims and their equivalents.

What is claimed is:

1. A method for creating a photo file while photographing with a camera mounted in a mobile communication terminal, comprising the steps of:
capturing an image using the camera;
determining whether schedule information registered in a scheduler program of the mobile communication terminal exists during the capturing;
reading preset information included in the registered schedule information when the registered schedule information exists during the capturing; and
generating a photo file corresponding to the captured image, the photo file including the read information.

2. The method of claim 1, further comprising:
compressing the photo file and the captured image;
storing the compressed the photo file and the captured image.

3. The method of claim 1, further comprising:
sending, by the mobile communication terminal, a request for schedule information to an adjacent mobile communication terminal over a Personal Area Network (PAN) when the registered schedule information does not exist during the capturing;
receiving the requested schedule information from the adjacent mobile communication terminal;
reading preset information from the received schedule information; and
generating a photo file corresponding to the captured image, the photo file including the information read from the received schedule information.

4. The method of claim 3, wherein the PAN performs communication using at least one of Bluetooth and ZigBee.

5. The method of claim 3, further comprising:
searching, by the adjacent mobile communication terminal, a phonebook to determine an intimacy with the mobile communication terminal upon receipt of the request for schedule information;
determining whether a previously registered schedule associated with the current time exists in the scheduler program when the intimacy is greater than or equal to a threshold; and
transmitting the schedule information to the mobile communication terminal when the previously registered schedule associated with the current time exists.

6. The method of claim 5, wherein the intimacy determination comprises determining the intimacy depending on at least one of whether a phone number of the mobile communication terminal is registered in a phonebook, a call frequency with the mobile communication terminal, a call time with the mobile communication terminal, a message transmission/reception frequency with the mobile communication terminal, whether a separate bell is appointed to the phone number of the mobile communication terminal, and whether a photo is registered in association with the phone number of the mobile communication terminal.

7. The method of claim 5, further comprising transmitting, by the adjacent mobile communication terminal, no schedule information when the intimacy is less than the threshold.

8. The method of claim 3, wherein the photo file creation comprises setting a name of the photo file, the name including the information read from the schedule information.

9. The method of claim 3, wherein the schedule information comprises at least one of event details, an event date, an event location, an event start time, and an event end time.

10. The method of claim 3, wherein the photo file creation comprises:
creating a photo folder with a name including an event location, event details, and an event date; and
creating, in the created photo folder, a photo file with a default name including the event location, the event details, the event date, and a file sequence number.

11. The method of claim 3, further comprising displaying the created photo file.

12. A mobile communication terminal for creating a photo file, comprising:
a camera module for converting an image captured by a camera lens into a digital signal, and creating image information by capturing consecutive digital signals in a still image;
a memory for storing a plurality of programs and information necessary for controlling an operation of the mobile communication terminal, and storing a scheduler program for a user; and
a controller for controlling the operation of the mobile communication terminal, capturing an image using the camera module, determining whether schedule information registered in the scheduler program of the mobile communication terminal exists during the capturing, reading preset information included in the registered schedule information when the registered schedule information exists during the capturing, and creating a photo file corresponding to the captured image, the photo file including the read information.

13. The mobile communication terminal of claim 12, wherein the controller compressing the photo file and the captured image, storing the compressed the photo file and the captured image to the memory.

14. The mobile communication terminal of claim 12, wherein the controller sends a request for schedule information to an adjacent mobile communication terminal over a Personal Area Network (PAN) when the registered schedule information does not exist during the capturing, receives the requested schedule information from the adjacent mobile communication terminal, reads preset information from the received schedule information, and generates a photo file corresponding to the captured image, the photo file including the information read from the received schedule information.

15. The mobile communication terminal of claim 12, further comprising a Personal Area Network (PAN) module for enabling communication with an adjacent mobile communication terminal using Bluetooth or ZigBee communication.

16. The mobile communication terminal of claim 14, wherein the schedule information comprises at least one of event details, an event date, an event location, an event start time, and an event end time.

17. The mobile communication terminal of claim 14, wherein the controller creates a photo folder with a name including an event location, event details, and an event date, and creates in the photo folder a photo file with a default name including the event location, the event details, the event date, and a file sequence number.
